(19) United States
(12) Patent Application Publication
(10) Pub. No.: US 2002/0191705 A1
(43) Pub. Date: Dec. 19, 2002

(54) Method and apparatus for peak prediction enabling peak-to-average ratio (PAR) reduction

(76) Inventors: Peter J. Melsa, Niles, MI (US); Thomas Nicholas Zogakis, Mountain View, CA (US)

Correspondence Address: TEXAS INSTRUMENTS INCORPORATED, P O BOX 655474, M/S 3999, DALLAS, TX, 75265

(21) Appl. No.: 09/874,759

(22) Filed: Jun. 5, 2001

(51) Int. Cl. H04L 27/04

(52) U.S. Cl. 375/295

(57) ABSTRACT

A method and an apparatus for predicting signal peaks and reducing signal peaks in transmitted data in a multicarrier transmission system. Said apparatus comprising a data input, a behavior model of filters in transmit path of said multicarrier transmission system, a circuit for applying said behavior model to said data input, a comparator for comparing data with a threshold, and a data output.

### FIELD OF THE INVENTION

This invention relates generally to communications systems, and more particularly, to a method and apparatus for predicting the presence of signal peaks in a signal and to use the prediction in a peak reduction scheme to reduce the magnitude of the large signal peaks, negating the requirement for larger and more expensive components needed to support the large signal peaks.

### BACKGROUND OF THE INVENTION

Discrete Multi-Tone (DMT) is a multicarrier transmission technique that divides available bandwidth of a connection into many subchannels. For example, DMT is used in the Asymmetric Digital Subscriber Line (ADSL) standard. ADSL transmits digital data over a twisted-pair connection and DMT is used to generate 256 separate 4.3125 kHz wide subchannels, starting at 4.3125 kHz to 1.104 MHz for downstream transmission (communications to the user) and 32 subchannels from 4.3125 Hz to 138 kHz for upstream transmission (communications from the user). DMT has been adopted by the ANSI T1E1.4 committee (in the United States) and the International Telecommunications Union (ITU) Study Group 15 (international) for use in ADSL systems and is specified in a technical standard from the same committees. In DMT, each subchannel is evaluated for its own individual transmission capacity and subchannels not capable of supporting data are not used, while data traffic on subchannels that are capable of supporting data traffic is maximized. This results in a communications channel where some subchannels are not used, some subchannels are lightly used, and some subchannels are heavily used. The amount of data traffic transmitted on each subchannel depends entirely on the amount of data that each subchannel is capable of delivering.

An important characteristic for a data signal in multicarrier transmission schemes is the data signal's peak-to-average ratio (PAR). The PAR of the data signal is defined as the ratio between the maximum value that the signal achieves divided by the average, usually the root-mean-squared (RMS), value of the signal. In multicarrier transmission techniques such as DMT, the data signal's PAR can be specified on a symbol-by-symbol basis. It is therefore possible for the data signal to have a symbol with a low PAR adjacent to another symbol with a high PAR.

It is common to observe that a data signal may have a relatively low average signal value and a very large PAR at the same time. This is due to the occurrence of a few peaks with large signal values. However, since PAR is a ratio, a data signal with a large PAR value may not necessarily mean that it has a large peak if its average value is very low, but this is a relatively rare occurrence and for the case of ADSL where the symbols are sufficiently long that this is normally not the case. A data signal with a large PAR value can place severe demands on digital-to-analog converters (DAC) within a transmitter, analog-to-digital converters (ADC) within a receiver, and power amplifiers and line drivers of both the transmitters and receivers. Data signals with large values of PAR increase power consumption and heat dissipation within power amplifiers and line drivers. The DACs, ADCs, power amplifiers, line drivers, power supplies, and cooling systems required to support signals with large PARs are also more expensive, and are typically larger and less efficient than their lower power equivalents.

Data signals with large signal peaks will usually cause power amplifiers and line drivers in a multicarrier transmission system to clip, i.e., the signal levels required to accurately represent the peaks exceeds the maximum value that the power amplifiers and line drivers are capable of producing. When the power amplifiers and line drivers clip, noise is introduced into the multicarrier transmission system, hence increasing the bit-error rate and reducing overall system performance.

One possible solution to the clipping problem would be to increase the maximum output level of the amplifiers and line drivers. This solution is an overly simple solution because increasing the maximum output level also increases the power consumption and heat dissipation of the multicarrier transmission system, not to mention the increased expense associated with system components possessing the higher performance capabilities required to provide the higher signal output levels. The increased power consumption and heat dissipation also requires larger and better power supplies and enhanced cooling systems. This may lead to a reduction in the number of multicarrier transmission systems allowable per installation due to the increased size of the power supplies and cooling systems. Additionally, by simply increasing the output level of the amplifiers and line drivers, the root problem of devising an acceptable solution for handling large peaks have not been solved, because the probability a peak of large magnitude occurring in the signal and causing the power amplifiers and line drivers to clip is still unacceptably high.

Additionally, in ADSL, the technical specifications as specified by ANSI and the ITU specifies a maximum average signal output level that can be transmitted and a maximum clipping rate allowed. This can be translated into a minimum sized signal peak that must be permitted to transmit without clipping. Therefore, a simple ADSL system cannot simply increase the maximum output level of the amplifiers and line drivers and still be compliant with the technical standards.

Designers of other multicarrier communications systems have devised more elaborate and robust solutions for reducing the effect of large signal peaks. One such solution involves detecting the presence of a peak in a data signal and then scaling the data signal appropriately to ensure that the peak does not exceed the maximum output level of the amplifiers and line drivers. However, since multicarrier systems operate with digital data in the frequency domain and peak detection is significantly simpler when the signal is represented digitally than when it is in its analog representation, most solutions involve detecting the presence of the peak and scaling the data signal while the data signal is represented digitally.

However, peak detection and scaling while the data signal is digital can be too early in the transmission process because the data signal is converted into its analog representation and undergoes further signal processing, including filtering and amplification, prior to transmission. Analog signal processing, i.e., filtering and amplification, can introduce signal changes that may possibly move a peak's location, alter the peak's magnitude, or eliminate the peak's presence altogether. Therefore, it is possible for the peak reduction scheme to scale a data signal that does not even contain a peak that would exceed the maximum output value, or scale the data signal by an insufficient amount, or not scale the data signal that does, in fact, contain a peak that exceeds the maximum permitted output value. A need has therefore arisen for a peak detection scheme that can accurately predict the occurrence of peaks in the data signal that would exceed the maximum permitted output value of the system.

### SUMMARY OF THE INVENTION

In one aspect, the present invention provides an apparatus for predicting signal peaks in a circuit comprising a data input, a model describing the behavior of filters in said circuit, a circuit for applying said model to said data, a comparator which is capable of selecting a data point from said data with a largest magnitude and comparing said data point with a threshold value, and an output for outputting result of said comparator.

In another aspect, the present invention provides an apparatus for reducing the magnitude of signal peaks in a circuit comprising a data input, an apparatus output, a model describing the behavior of filters in said circuit, a circuit for applying said model to said data, a comparator which is capable of selecting a data point from said data with a largest magnitude and comparing said data point with a threshold value, an output for outputting result of said comparator, and a scaling circuit adapted to scaling said data dependent on output of said comparator.

The present invention has an advantage in that it allows for accurate prediction of signal peaks in a data signal, permitting the multicarrier transmission system to reduce the magnitude of the signal peaks prior to amplification and transmission. The reduction in the magnitude of the signal peaks result in multicarrier transmission systems that operate more efficiently and use less power.

Another advantage of the present invention is that for a given maximum output level, it can support larger signal peaks without resorting to clipping. Alternatively, it will support the same size signal peak at a lower maximum output level.

### BRIEF DESCRIPTION OF THE DRAWINGS

The above features of the present invention will be more clearly understood from consideration of the following descriptions in connection with accompanying drawings in which:

FIG. 1.a is a diagram illustrating a portion of a data symbol with a large signal peak;

FIG. 1.b is a diagram illustrating a portion of a data symbol with a large signal peak exceeding a prespecified threshold;

FIG. 1.c is a diagram illustrating a portion of a data symbol as shown in FIG. 1.b after amplification with the large signal peak being clipped due to its excess magnitude;

FIG. 2 is a diagram illustrating a preferred embodiment of the present invention;

FIG. 3 is a diagram illustrating a second preferred embodiment of the present invention; and

FIG. 4 is a diagram illustrating a third preferred embodiment of the present invention.

### DETAILED DESCRIPTION OF ILLUSTRATIVE EMBODIMENTS

The making and use of the various embodiments are discussed below in detail. However, it should be appreciated that the present invention provides many applicable inventive concepts which can be embodied in a wide variety of specific contexts. The specific embodiments discussed are merely illustrative of specific ways to make and use the invention, and do not limit the scope of the invention.

Refer now to FIG. 1.a for a diagram illustrating peak-to-average ratio (PAR) and the damaging effects of clipping on a portion of a data symbol. The portion of a data symbol is shown as a trace 110 displaying signal values on a set of axes 112. The data symbol portion has one large signal peak 115. The data symbol portion also has an average value, typically the root-mean-squared (RMS) value but other metrics may be used, shown as a dashed line 120. The diagram also displays a threshold 125, a predetermined value that is a function of a maximum output level provided by power amplifiers and line drivers used in a multicarrier transmission system. The large signal peak 115 does not exceed the threshold 125 and is shown on the axes 112 as being lower in height that the threshold 125.

Refer now to FIG. 1.b for a second set of axes 122 displays the signal values for a portion of another data symbol. The signal values of the data symbol portion are shown as trace 130 and are for the data symbol portion prior to being amplified. Trace 130 has a peak that exceeds the threshold 125. FIG. 1.c displays a third set of axes 127 displays the same data symbol portion shown in the second set of axes 122 after it has been amplified. Because the original data symbol portion had a peak that exceeds the threshold 125, the data symbol, after amplification, has been clipped. The clipped data symbol's signal values are shown as trace 135. Because the data symbol has been clipped, noise has been injected into the data symbol and some of the data in the data symbol may have been lost. If data was lost, the data symbol will be marked as containing an error, and depending on which communications protocol is being used, a retransmit of the data symbol may be requested. However, since the data symbol was damaged by the clipping and not by errors incurred during transmission, the retransmitted data symbol will also be marked as a damaged symbol. This clip—detect an error—retransmit cycle can seriously degrade performance in the multicarrier transmission system.

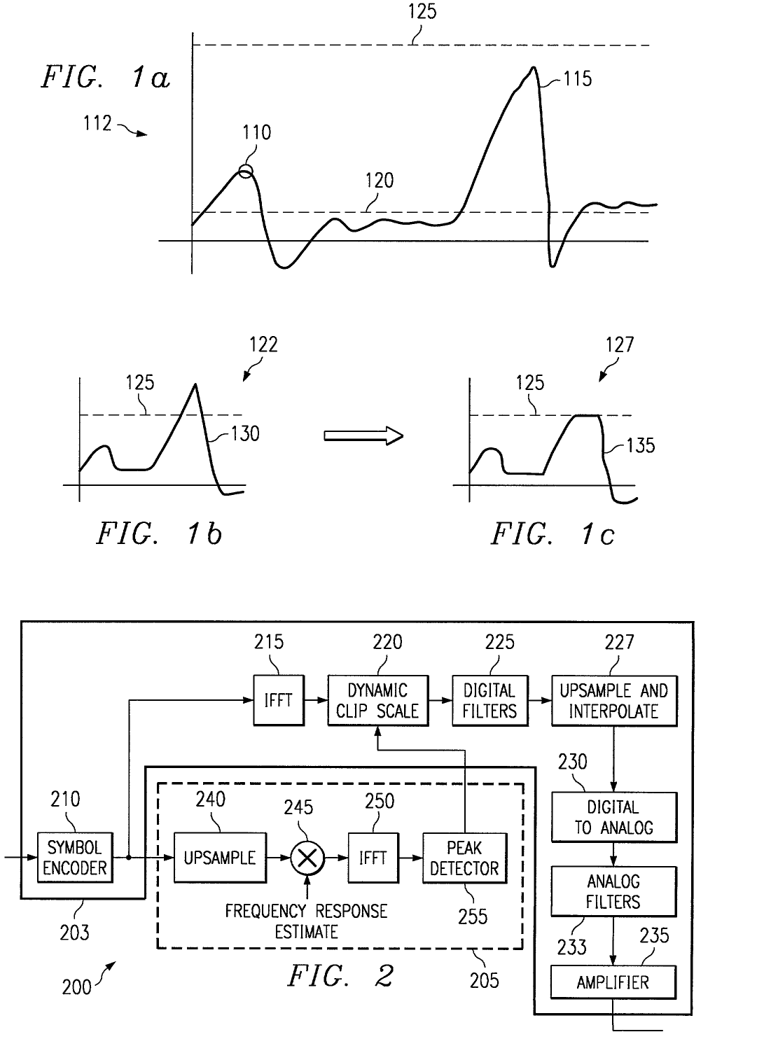

Refer now to FIG. 2 for a diagram illustrating a multicarrier transmission system 200 comprising a transmit path 203 and a peak detecting apparatus 205 for the purposes of predicting the presence of peaks within a data symbol. For description purposes, the ADSL standard will be used in the description of the preferred embodiments of the present invention. However, the present invention is not limited to ADSL. The present invention is applicable to any multicarrier transmission technique as well as single carrier transmission techniques. As the discussion of the multicarrier transmission system 200 progresses, the data symbol, both in terms of how it is represented (time or frequency domains) and its contents (the data it contains), will change as it is operated upon and modified by various circuits in the multicarrier transmission system 200. The data symbol will be referred to with different names to designate that it has been modified. However, should the data symbol be simply referred to as the data symbol, it will refer to the data symbol being processed in the particular portion of the multicarrier transmission system 200 that is currently being discussed.

The transmit path 203 is comprised of a symbol encoder 210 with an input for receiving user data. The symbol encoder 210 receives a symbol's worth of data at a time and encodes it into a frequency domain data symbol. The frequency domain data symbol represents a 232-microsecond block of data samples and 512 data points are used to represent the data in the frequency domain data symbol. However, the peak detecting circuit 205 is operable with data symbols of any size and any arbitrary number of data points per data symbol. The 232-microsecond block duration is as specified by the ANSI T1E1.4 committee and the ITU. The symbol encoder 210 performs a bit allocation operation wherein it determines how many bits are assigned to each subchannel frequency and generates a frequency domain representation of the bits at the assigned subchannel frequencies. A discussion of how the symbol encoder 210 performs the bit allocation is beyond the scope of this discussion and is not included herein.

Coupled to the symbol encoder 210 is an inverse Fast Fourier Transform (IFFT) block 215. Inverse Fast Fourier Transforms are used to convert data from the frequency domain into the time domain. In the preferred embodiment of the present invention, the IFFT block 215 converts the frequency domain data symbol into a time domain data symbol. Given that the frequency domain data symbol is represented by 512 data points, the IFFT block 215 must be a 512-point IFFT and the time domain data symbol is also represented by 512 data points. Again, it must be mentioned that the preferred embodiment of this invention can operate on data symbols of any size and duration, and that the 512 data points used to represent the data symbol is specified by the ANSI T1E1.4 committee and the ITU and should not be construed as being a limitation of the present invention. Coupled to the IFFT 215 is a dynamic clip-scaling block 220. The dynamic clip-scaling block 220 has a first input, coupled to the IFFT 215, where it receives the time domain data symbol. The dynamic clip-scaling block 220 has a second input, coupled to the peak detecting apparatus 205, where it receives control information. The control information from the peak detecting apparatus 205 includes instructions on whether or not to scale the time domain data symbol currently in the dynamic clip-scaling block 220 and if scaling is to be performed, how much to scale. In the preferred embodiment of the present invention, the scaling is done in single decibel (dB) increments and in the downward direction, i.e., the time domain data symbol is only decreased in magnitude. However, it is possible to implement the dynamic clip-scaling block 220 so that the dynamic clip-scaling block will be able to scale the time domain data symbol by any arbitrary amount and to also increase its magnitude as well as decrease its magnitude.

After exiting the dynamic clip-scaling block 220, the time domain data symbol (scaled or not scaled by the dynamic clip-scaling block 220) is filtered by a digital filter 225. The digital filter 225 enforces spectral limits on the time domain data symbol such as high pass filtering to make sure that the time domain data symbol has no spectral components that would interfere with speech data being carried on the same twisted-pair and/or low pass filtering to remove any spectral components that exceed the maximum allowed frequency. After filtering, the time domain data symbol is upsampled and interpolated (block 227) and then converted into an analog data symbol (block 230). The upsample and interpolation block 227 allows the system to upsample the time domain data symbol to a higher frequency, which in turn allows the digital-to-analog converter 230 to run at a higher rate and achieve better performance. Analog filters 233 are used to provide some final shaping to the analog data symbol to ensure that the analog data symbol fits within the ADSL technical specifications. An amplifier 235 brings the analog data symbol to an appropriate signal level. Finally, the analog data symbol is transmitted to a destination. For ADSL application, the analog data symbol is transmitted over a twisted-pair transmission medium. However, neither the preferred embodiment of the present invention nor DMT is limited to using twisted-pair as the sole transmission medium or ADSL as a technical specification.

The peak detecting apparatus 205 has a single data input, coupled to the output of the symbol encoder 210. Because the operation of the peak detecting apparatus 205 is destructive to data, the peak detecting apparatus 205 operates on a copy of the frequency domain data symbol. It should be apparent to a person practiced in the art of the present invention that the peak to detecting apparatus 205 could operate upon the actual frequency domain data symbol, instead of a copy of the frequency domain data symbol. In order to do so, the peak detecting apparatus 205 would need to either save a copy of the frequency domain data symbol or save sufficient information to allow the recovery of the frequency domain data symbol from the modifications that the peak detecting apparatus 205 applies to the frequency domain data symbol.

The peak detecting apparatus 205 contains an upsampling circuit 240.

The upsampling technique used in the upsampling circuit 240 is the well-known conjugate and flip technique used for upsampling frequency domain data. This operation is equivalent to a zero-fill interpolation in the time domain. The copy of the frequency domain data symbol is upsampled to increase the number of data points used to represent the signal, i.e., increase the resolution in the representation of the signal. In the preferred embodiment of the present invention, upsampling of the copy of the frequency domain data symbol is performed by calculating a complex conjugate of the data symbol and then performing a flipping operation on the complex conjugate. Methods for upsampling other than conjugate and flip are available and the present invention should not be construed as being limited solely to using the upsampling technique of calculating the complex conjugate and flipping.

Each time the copy of the frequency domain data symbol is upsampled, the number of data points representing the copy of the frequency domain data symbol is doubled. If the copy of the frequency domain data symbol is upsampled two times, then the number of data points has increased four times, from 512 to 2048, while upsampling once results in the doubling of the number of data points from 512 to 1024. Given that the data symbol duration remains fixed at 232-microseconds, the spacing between the data points is reduced. Hence, the resolution increases and the probability of finding a peak also increases. It is well known in the art that upsampling in the frequency domain produces copies of the original frequency domain data that are shifted upwards in frequency. For example, by upsampling the data symbol twice, three copies of the frequency domain data are created, resulting in a total of four images. However, the upsampling is optional and the copy of the frequency domain data symbol does not need to be upsampled in order for the preferred embodiment of the present invention to operate properly.

After upsampling (if present), the copy of the frequency domain data symbol is multiplied with a frequency response estimate in a multiplier 245. The frequency response estimate is a combination of frequency responses for all filters in the multicarrier transmission system 200. Every filter (both analog and digital filters) in the multicarrier transmission system 200 can be characterized by their frequency response and the frequency response estimate is simply the combination of all such frequency responses. Multiplication in the frequency domain is analogous to convolution in the time domain. So, the multiplier 245 is, in essence, performing a filtering operation on the copy of the frequency domain data symbol with the frequency responses of all remaining filters in the multicarrier transmission system 200.

The result of the multiplication by the multiplier 245 is a prediction of what the frequency domain data symbol will look like as it is transmitted over the twisted-pair, with the differences being that the result of the multiplication is not amplified to final transmitting voltage levels, is in the frequency domain, and is digitally represented. The actual data symbol that is transmitted over the twisted-pair is analog, amplified, and in the time domain. The result of the multiplication is referred to as a predictor, and the predictor, if converted into the time domain and represented in analog form, would look similar to an unamplified version of the data symbol as it is transmitted over the twisted-pair. However, should the desire exist, the frequency response estimate may be adjusted to that it would impart onto the predictor an appropriate amount of gain so that the predictor would, in fact, look like the data symbol as it is transmitted over the twisted-pair.

The predictor is converted into its time domain representation by a second inverse Fast Fourier Transform circuit 250, producing a time domain predictor. The size of the IFFT 250 must match the size of the copy of the frequency domain data symbol (potentially upsampled). If the copy of the frequency domain data symbol had been upsampled two times, increasing its size to 2048 data points, then the IFFT 250 must also be a 2048-point IFFT. The conversion from the frequency domain into the time domain by IFFT 250 is needed to facilitate searching for peaks within the time domain predictor because peak detection is easier to perform on time domain data. While peak detection in the time domain is easier to perform than peak detection in the frequency domain, peak detection in the frequency domain is certainly possible. A peak detector circuit 255 performs the search for peaks within the time domain predictor. The peak detector circuit 255 first performs a search upon the time domain predictor for a data point with the largest magnitude. If there are multiple data points with the same largest magnitude, then the peak detector 255 will simply select one of these data points. In another preferred embodiment of the present invention, the peak detector 255 would employ a simple heuristic to select one data point from the set of data points that all have the same magnitude. The peak detector 255 then compares the selected data point with a threshold. The threshold is a function of the maximum voltage value that the power amplifiers and line drivers can support without the occurrence of clipping. If the selected data point exceeds the threshold, then the peak detector 255 will signal the dynamic clip-scaling block 220 to scale the time domain data symbol and by how much. If the selected data point is less than the threshold, then the peak detector 255 will signal the dynamic clip-scaling block 220 to not scale the time domain data symbol. In the case of the selected data point being equal to the threshold, the peak detector 255 will either signal the dynamic clip-scaling block 220 to scale the time domain data symbol or not to scale the time domain data symbol, depending on an arbitrarily made decision by designers of the multicarrier transmission system 200.

The advantages of upsampling, namely increased resolution and increased probability of finding a peak value, were discussed previously. However, upsampling has a negative side effect as well. Increasing the number of data points representing the data symbol results in an increased computation time for computing the inverse Fast Fourier Transform (block 250). However, due to the low pass nature of the digital filters 225 and analog filters 233 used in the transmit path 203, significant portions of the upsampled data symbol are essentially zeroed after the data symbol and the frequency response estimates are multiplied (block 245). Taking advantage of this, several images of the upsampled data symbol can be zeroed out. In the case of a data symbol that has been upsampled twice, up to three out of the four images can be zeroed out. In practice, two images can be zeroed out without losing significant accuracy in the predictor. The net effect of zeroing out two out of four images is that the increased resolution gained by upsampling is retained while the higher frequency components generated by the upsampling is discarded. Taking advantage of widely known implementations of the inverse Fast Fourier Transform algorithm, the net effect of zeroing out two out of the four images is to bring the computation time for the 2048-point inverse Fast Fourier Transform back in line with the computation time for 1024-point inverse Fast Fourier Transform.

Refer now to FIG. 3 for a diagram displaying a multicarrier transmission system 300 with a peak predicting apparatus 305 according to a second preferred embodiment of the present invention. Persons practiced in the art of the present invention will realize that the peak predicting apparatus 205 discussed previously uses circular convolution rather than linear convolution. The use of circular convolution assumes that each data symbol in the sequence of data symbols is independent of the data symbol that immediately preceded and follows it. However, the data symbols are not independent of each other and there is some history between the data symbols. In practice, the use of circular convolution has resulted in a peak predictor that does result in some loss in the accuracy of the peak predictor, but the measured performance of the peak predictor has been sufficient.

The history between data symbols can be preserved if the widely known technique of overlap and add is used to implement linear convolution rather than using simple circular convolution. Circular convolution can be made into linear convolution if the circular convolution is of sufficient length. If the length of the circular convolution is equal to or greater than the sum of the length of the two sequences being convolved minus one, then circular convolution is equal to linear convolution. This is typically done by padding zeros to one of the time domain signals. The peak detecting apparatus 305, displayed in FIG. 3, uses the well known overlap and add technique to implement linear convolution. The multicarrier transmission system 300 has a transmit path 303 that is identical to the transmit path 203 of the multicarrier transmission system 200 displayed in FIG. 2. But, as would be expected, the peak detecting apparatus 305 is significantly different. The peak detecting apparatus 305 accepts as input a time domain data symbol (output of IFFT block 315) rather than a frequency domain data symbol. This is necessary because the peak detecting apparatus 305 first must append a sufficient number of zeros to the time domain data symbol to ensure that the circular convolution it is performing is equivalent to linear convolution. Because data symbols are 512 data points long and because of well-known algorithms for convolution, Fast Fourier Transform, and inverse Fast Fourier Transform, data symbols are kept to a length that is equal to a power of 2, 512 zeros are appended to the copy of the time domain data symbol to create a 1024 data point time domain data symbol.

After appending the sufficient number of zeros (block 345), creating a zero appended time domain data symbol, a Fast Fourier Transform (FFT) is performed in a FFT block 350 to convert the zero appended time domain data symbol back into the frequency domain. Since the zero appended time domain data symbol is 1024 data points long, the FFT block 350 must perform a 1024-point FFT. The FFT block 350 creates a zero appended frequency domain data symbol. An upsample block (355), a multiplier 360, and an inverse Fourier Transform block 365 are identical to the corresponding blocks in FIG. 2. Once again, the IFFT block 365 must implement an IFFT that matches the length of a zero appended time domain data symbol produced by the upsample block 355.

After generating a frequency domain predictor (output of multiplier 360) and converting it back into the time domain (output of IFFT 365), the peak detecting apparatus 305 must save a copy of the zero appended time domain data symbol (block 367) for later use. The overlap and add block 370 implements the overlap and add operation. The overlap and add operation is a basic digital signal processing operation and will not be discussed here. The delay block, as stated previously, saves a copy of the current zero appended time domain data symbol for use with the next zero appended time domain data symbol. After the delay and overlap and add block 370, the corrected data symbol enters a peak detector 375. The peak detector 375 is identical to the peak detector 255 from FIG. 2 and produces control signals controlling the operation of the dynamic clip-scaling block 320.

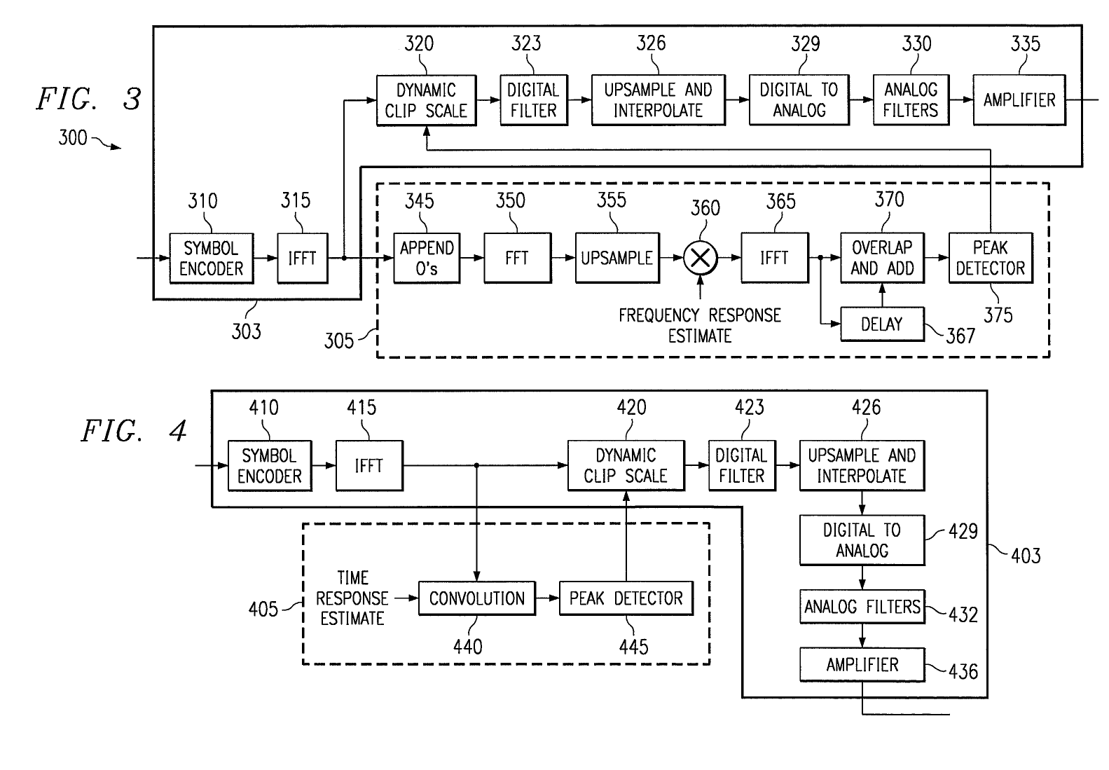

The time domain and the frequency domain can be envisioned as being duals of one another. An operation in the time domain has a corresponding dual in the frequency domain and vice versa. For example, a convolution in the time domain is a dual to a multiply operation in the frequency domain. The first preferred embodiment of the present invention presented the peak detecting apparatus 205 that operates with frequency domain signals. There is also a dual to the peak detecting apparatus 205 that operates with time domain signals. Refer now to FIG. 4 for a diagram illustrating a multicarrier transmission system 400 with a peak detecting apparatus 405 that operates with time domain signals. The multicarrier transmission system 400 has a transmit path 403 that is identical to the transmit path 303 of the multicarrier transmission system 300 displayed in FIG. 3.

The peak detecting apparatus 405 is comprised of a convolution block 440 and a peak detector 445. The convolution block 440 performs a convolution of a time domain data symbol with a time response estimate. In another preferred embodiment of the present invention, the time domain symbol (the output of block IFFT 415) is upsampled by a time domain upsampling circuit (not shown in FIG. 4) prior to entering the convolution block 440. The time response estimate is the dual of the frequency response estimate used in other preferred embodiments of the peak detecting apparatus 205 and 305. The time response estimate is a convolution of all time response estimates for every filter (both analog and digital filters) in the multicarrier transmission system 400. The convolution of the time response estimate and the time domain data symbol produces a time domain predictor that is a prediction of what the time domain data symbol will look like before it is transmitted over the twisted-pair medium. The time domain predictor is input for the peak detector circuit 445. The peak detector circuit 445 operates in the same manner as the other peak detectors 255 and 375 previously discussed, with its output controlling the operation of a dynamic clip-scaling block 420.

The discussion of the preferred embodiment of the present invention as presented in these specifications describes the invention being implemented on a special purpose digital signal processor (DSP). However, the preferred embodiment of the present invention can be implemented on a general purpose DSP, a generic microprocessor, or specially designed hardware and firmware.

As will be apparent from the above description, the preferred embodiments provide several advantageous features including a reduction in overall power usage in the multicarrier transmission system due to a reduction in a power supply voltage for power amplifiers and line drivers.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for predicting signal peaks in data in a circuit comprising the steps of:
creating a behavioral model of filters in transmit path of said circuit;
applying said behavioral model to a copy of said data, producing applied data;
selecting a data point in said applied data with largest magnitude;
comparing said data point with a threshold; and
outputting results of said comparison.

2. A method according to claim 1, wherein:
said data is frequency domain data;
said behavioral model of filters is a frequency response estimate of filters in transmit path of said circuit;
said step of applying said behavioral model to the copy of said data is multiplying said frequency response estimate with the copy of said data;
said step of comparing said data point with a threshold is with converted time data; and
said method further comprising the step of converting said applied data into a time domain representation of same, producing said converted time data.

3. A method according to claim 2, further comprising the step of upsampling said copy of said data.

4. A method according to claim 2, wherein:
said step of applying said behavioral model to the copy of said data is done to a symbol of said data at a time, creating an applied data symbol;
said method further comprising the steps of:
partitioning said data into symbols;
saving said applied data symbol; and
adding said applied data symbol with said applied data symbol generated from previous symbol.

5. A method according to claim 4, further comprising the step of upsampling said copy of said data.

6. A method according to claim 1, wherein:
said data is time domain data;
said behavioral model of filters is a time response estimate of filters in transmit path of said circuit; and
said step of applying said behavioral model to said copy of said data is convolving said time response estimate with the copy of said data.

7. A method according to claim 6, further comprising the step of upsampling said copy of said data.

8. A method for peak reduction of data in a circuit comprising the steps of:
creating a behavioral model of filters in transmit path of said circuit;
applying said behavioral model to a copy of said data, producing applied data;
selecting a data point in said applied data with largest magnitude;
comparing said data point with a threshold; and
scaling magnitude of said data if said data point exceeds said threshold.

9. A method according to claim 8, wherein:
said data is frequency domain data;
said behavioral model of filters is a frequency response estimate of filters in transmit path of said circuit;
said step of comparing said data point with a threshold is with converted time data;
said step of applying said behavioral model to a copy of said data is multiplying said frequency response estimate with the copy of said data; and
said method further comprising the step of converting said applied data into a time domain representation of same, producing said converted time data.

10. A method according to claim 9, further comprising the step of upsampling said copy of said data.

11. A method according to claim 9, wherein:
said step of applying said behavioral model to the copy of said data is done to a symbol of said data at a time, creating an applied data symbol;
said method further comprising the steps of:
partitioning said data into symbols;
saving said applied data symbols; and
adding said applied data symbol with said applied data symbol generated from previous symbol.

12. A method according to claim 11, further comprising the step of upsampling said copy of said data.

13. A method according to claim 8, wherein:
said data is time domain data;
said behavioral model of filters is a time response estimate of filters in transmit path of said circuit; and
said step of applying said behavioral model to the copy of said data is convolving said time response estimate with the copy of said data.

14. A method according to claim 13, further comprising the step of upsampling said copy of said data.

15. An apparatus for peak prediction in a circuit comprising:
a data input, adapted to inputting data;
a behavior model of filters in transmit path of said circuit;
an application circuit, having a first input coupled to said data input and a second input coupled to said behavior model and an output coupled to a comparator, adapted to applying said behavior model to said data, producing applied data;
said comparator, having an input coupled to said output of said application circuit and an output coupled to an apparatus output, adapted to selecting a data point from said applied data with a largest magnitude and comparing said data point with a threshold value; and
said apparatus output, outputting result of said comparator.

16. An apparatus according to claim 15, wherein said data is partitioned into 512 data point symbols and represents 232 microseconds of time.

17. An apparatus according to claim 15, wherein:
said data is frequency domain data;
said behavior model of filters is a frequency response estimate of filters in transmit path of said circuit;
said application circuit is a multiplier, having a first input coupled to said frequency response estimate and a second input coupled to said data, adapted to multiplying said frequency response estimate with said data; and
said apparatus further comprising an inverse Fast Fourier Transform (FFT) circuit, having an input coupled to said output of said application circuit and an output coupled to said input of said comparator, adapted to converting said applied data into time domain representation of same.

18. An apparatus according to claim 17, further comprising an upsample circuit, having an input coupled to said data input and an output coupled to said first input of said multiplier, adapted to upsample a copy of said data.

19. An apparatus according to claim 18, wherein said upsample circuit upsamples said data by calculating a complex conjugate of said data and then flipping said complex conjugate.

20. An apparatus according to claim 18, wherein a number of upsampled data images are set to zero to reduce computation complexity and increase computation speed in said inverse FFT circuit.

21. An apparatus according to claim 15, wherein:
said data is time domain data;
said behavior model of filters is a time response estimate of filters in transmit path of said circuit; and
said application circuit is a convolution circuit, having a first input coupled to said time response estimate and a second input coupled to said data, adapted to convolving said time response estimate with said data.

22. An apparatus according to claim 21, further comprising an upsample circuit, having an input coupled to said data input and an output coupled to said first input of said multiplier, adapted to upsample a copy of said data.

23. An apparatus for peak reduction in a circuit comprising:
a data input, adapted to inputting user data;
an apparatus output;
a behavior model of filters in transmit path of said circuit;
an application circuit, having a first input coupled to said data input and a second input coupled to said behavior model and an output coupled to a comparator, adapted to applying said behavior model to said user data, producing applied data;
said comparator, having an input coupled to said application circuit and an output coupled to a scaling circuit, adapted to selecting a data point from said applied data with a largest magnitude and comparing said data point with a threshold value; and
said scaling circuit, having a first input coupled to said data input and a second input coupled to said comparator and an output coupled to said apparatus output, adapted to scaling the magnitude of said applied data if said comparator determines that said data point exceeds said threshold value, outputting said applied data if said comparator determines that said data point does not exceed said threshold value and a scaled version of said applied data if said comparator determines that said data point does exceed threshold value.

24. An apparatus according to claim 23, wherein:
said data is frequency domain data;
said behavior model of filters is a frequency response estimate of filters in transmit path of said circuit;
said application circuit is a multiplier, having a first input coupled to said frequency response estimate and a second input coupled to said data, adapted to multiplying said frequency response estimate with said data;
said apparatus further comprising:
a first inverse Fast Fourier Transform (FFT) circuit, having an input coupled to said output of said application circuit and an output coupled to said input of said comparator, adapted to converting said applied data into time domain representation of same;
a second inverse FFT circuit having an input coupled to said data input and an output coupled to said first input of said scaling circuit, adapted to converting said data into a time domain representation of same, producing applied data.

25. An apparatus according to claim 24, further comprising an upsample circuit, having an input coupled to said data input and an output coupled to said first input of said application circuit, adapted to upsample a copy of said data.

26. An apparatus according to claim 23, wherein:
said data is time domain data;
said behavior model of filters is a time response estimate of filters in transmit path of said circuit; and
said application circuit is a convolution circuit, having a first input coupled to said time response estimate and a second input coupled to said data, adapted to convolving said time response estimate with said data.

27. An apparatus according to claim 26 further comprising an upsampling circuit, having an input coupled to said data input and an output coupled to said first input of said application circuit, adapted to upsample a copy of said data.

28. An apparatus according to claim 23, wherein said scaling circuit scales said signal in one decibel (dB) increments in a downward direction.

29. A data transmission system with built-in circuitry for reducing a peak-to-average ratio in said data comprising:
a data input, adapted to inputting user data;
a symbol encoder, having an input coupled to said data input and an output coupled to a scaling circuit and an apparatus input, adapted to encode data from said data input into a data symbol;
said scaling circuit, having a first input coupled to said symbol encoder and a second input coupled to an apparatus output of an apparatus for predicting signal peaks and an output coupled to a data output, adapted to reducing magnitude of said data symbol if said apparatus predicts a signal peak exceeding a threshold value, outputting said data symbol if said apparatus does not predict a signal peak exceeding said threshold value and a scaled version of said data symbol if said apparatus does predict a signal peak exceeding said threshold value;
said data output, coupled to said scaling circuit, adapted to outputting said output of said scaling circuit;
wherein said apparatus for predicting signal peaks, having said apparatus input coupled to said output of said symbol encoder and said apparatus output coupled to said second input of said scaling circuit, further comprising:
a behavior model of filters in transmit path of said data transmission system;
an application circuit, having a first input coupled to said apparatus input and a second input coupled to said behavior model and an output coupled to a comparator, adapted to applying said behavior model to said data symbol, producing applied data;
said comparator, having an input coupled to said application circuit and an output coupled to said apparatus output, adapted to selecting a data point from said applied data with a largest magnitude and comparing is said data point with said threshold value; and
said apparatus output, adapted to outputting result of said comparator.

30. An apparatus according to claim 29, wherein:
said data is frequency domain data;
said behavior model of filters is a frequency response estimate of filters in transmit path of said circuit;
said application circuit is a multiplier, having a first input coupled to said frequency response estimate and a second input coupled to said data, adapted to multiplying said frequency response estimate with said data;
said apparatus further comprising:
a first inverse FFT circuit, having an input coupled to said output of said application circuit and an output coupled to said input of said comparator, adapted to converting said applied data into time domain representation of same; and
a second inverse FFT circuit having an input coupled to said data input and an output coupled to said first input of said scaling circuit, adapted to converting said data into a time domain representation of same, producing applied data.

31. An apparatus according to claim 30, further comprising an upsample circuit, having an input coupled to said output of said symbol encoder and an output coupled to said first input of said application circuit, adapted to upsample a copy of said data.

32. An apparatus according to claim 29, wherein:
said data is time domain data;
said behavior model of filters is a time response estimate of filters in transmit path of said circuit;
said application circuit is a convolution circuit, having a first input coupled to said time response estimate and a second input coupled to said data, adapted to convolving said time response estimate with said data; and
wherein said data transmission system further comprised of an inverse FFT circuit, having an input coupled to said output of said symbol encoder and an output coupled to said first input of said scaling circuit and said second input of said application circuit, adapted to converting said data into a time domain representation of same, producing a data symbol.

33. An apparatus according to claim 32 further comprising an upsampling circuit, having an input coupled to said data input and an output coupled to said first input of said application circuit, adapted to upsample a copy of said data.

34. An apparatus of claim 29 wherein said data output further comprising:
a digital filter, having an input coupled to said output of said scaling circuit and an output coupled to an upsample and interpolation circuit, adapted to filtering said data output;
said upsample and interpolation circuit, having an input coupled to said digital filter and an output coupled to a digital-to-analog converter circuit, adapted to upsampling and interpolating said data output;
said digital-to-analog converter circuit, having an input coupled to said upsample and interpolation circuit and an output coupled to an analog filter; adapted to converting said data output into an analog representation of same;
said analog filter, having an input coupled to said digital-to-analog converter circuit and an output coupled to an amplifier, adapted to filtering said analog data output; and
said amplifier; having an input coupled to said analog filter and an output coupled to a transmission medium, adapted to amplifying said analog data output to a specified magnitude.
